(19) United States
(12) Patent Application Publication
(10) Pub. No.: US 2019/0113282 A1
(43) Pub. Date: Apr. 18, 2019

(54) Permeable Bottom Crucible

(71) Applicant: Porvair PLC, Norfolk (GB)

(72) Inventors: Eric Feiner, Gilberts, IL (US); Rudolph A. Olson, III, Hendersonville, NC (US); Kurt Schiefelbein, Gilberts, IL (US)

(21) Appl. No.: 16/156,333

(22) Filed: Oct. 10, 2018

Related U.S. Application Data
(60) Provisional application No. 62/571,458, filed on Oct. 12, 2017.

(51) Int. Cl. F27B 14/10; C22B 9/05; F27B 14/06

(52) U.S. Cl. CPC F27B 14/10; B28B 1/50; F27B 14/061; C22B 9/05

(57) ABSTRACT

An improved permeable bottom crucible is provided. The permeable bottom crucible is particularly suitable for degassing molten metal. The permeable bottom crucible comprises a refractory ceramic body comprising walls and an integral bottom wherein the integral bottom has a porous portion. The porous portion has a porosity which is higher than a porosity of the walls. Inductive coils are around the refractory ceramic body. A plug is arranged to disperse gas through the porous portion.

### CROSS-REFERENCE TO RELATED APPLICATIONS

This application claims the priority benefit under 35 U.S.C. section 119 of pending U.S. Provisional Patent Application No. 62/571,458 filed on Oct. 12, 2017 which is incorporated by reference.

### FIELD OF THE INVENTION

The present invention is related to a composite refractory ceramic permeable bottom crucible incorporating an integral gas permeable area that allows a pressurized gas to flow preferentially through a permeable portion forming the bottom of the permeable bottom crucible. This composite permeable bottom crucible is particularly suited for refining and homogenizing molten metal.

### BACKGROUND

When processing steel of various grades it is often advantageous to bubble a gas through the molten metal. The gas, typically argon, passing through the melted metal removes unwanted gases and oxide impurities. The result is a more chemically and thermally homogenous melt.

Lances, purge plugs, and various other methods are known to be used for the introduction of gases into large melts such as those in excess of 1,000 pounds. This degassing process is typically done in metal within a lined crucible energized by an inductor coil as illustrated in FIGS. 1 and 2 in cross-sectional schematic view. In FIGS. 1 and 2 a lined crucible is illustrated comprising a shell, 14, with a crucible, 12, disposed therein. An inductor coil, 16, wraps around the shell to provide sufficient heat to melt the metal in the lined crucible.

To provide purge gas a purge plug is typically attached to the shell. In FIG. 1, the purge plug, 18, having an integral gas supply line, 20, is inserted into the shell and gas, 24, permeates through a preformed hole, 22, in the crucible. FIG. 2 differs from FIG. 1 in that the purge plug, 18, is engaged with the preformed hole in the crucible in FIG. 2. These techniques have been suitable for large crucibles, such as those containing over 1,000 pounds, where loss due to failure at the various junctions of purge plug, crucible and shell are accepted due to the large volume of material processed. Furthermore, the purge plug in contact with the molten metal, as in FIG. 2, reduces the useful life of the purge plug.

In investment casting, it is common to process melts in amounts which are much smaller than 1,000 pounds. With the smaller volumes the losses acceptable with large castings are no longer acceptable and those techniques suitable for large castings are not commercially viable. Other techniques have been attempted, such as an entirely permeable crucible coated with a sealant to create areas of lower permeability. These alternative methods have met with limited success due to the increase in erosion, corrosion and abrasion.

The present invention provides an improved system for melting and gas purging metals. The present invention eliminates many of the problems associated with the prior art and provides a robust system particularly suitable for use on smaller scale melts, such as investment casting, without limit thereto.

### SUMMARY OF THE INVENTION

The invention is related to an improved system for melting, and purging, molten metal and a system for making the improved system.

More specifically, the present invention is related to improved permeable bottom crucible with an integral purge system thereby eliminating the presence of joints between materials of different composition.

A particular feature of the invention is the ability to form a permeable bottom crucible having an integral portion with a predefined porosity and size.

These and other embodiments, as will be realized, are provided in a permeable bottom crucible for degassing molten metal. The permeable bottom crucible comprises a refractory ceramic body comprising walls and an integral bottom wherein the integral bottom has a porous portion. The porous portion has a porosity which is higher than a porosity of the walls. Inductive coils are around the refractory ceramic body. A plug is arranged to disperse gas through the porous portion.

Yet another embodiment is provided in a method of forming a permeable bottom crucible. The method includes:
forming a mold wherein the mold has a shape of the permeable bottom crucible; inserting an exclusion member in the mold;
inserting a ceramic precursor in the mold wherein the ceramic precursor fills the mold thereby forming a dense ceramic precursor;
removing the exclusion member thereby forming a vacancy in the dense ceramic precursor;
filling the vacancy with a modified ceramic precursor wherein the modified ceramic precursor comprises porosity increasing additives thereby forming a permeable bottom crucible precursor; and
heating the permeable bottom crucible precursor to from a permeable bottom crucible comprising walls and a bottom wherein the bottom comprises a permeable portion.

### BRIEF DESCRIPTION OF FIGURES

FIG. 1 is a cross-sectional schematic view of a prior art crucible.

FIG. 2 is a cross-sectional schematic view of a prior art crucible.

FIG. 3 is a cross-sectional schematic view of embodiment of the invention.

FIG. 4 is a cross-sectional schematic view of embodiment of the invention.

FIG. 5 is a flow chart representation of an embodiment of the invention.

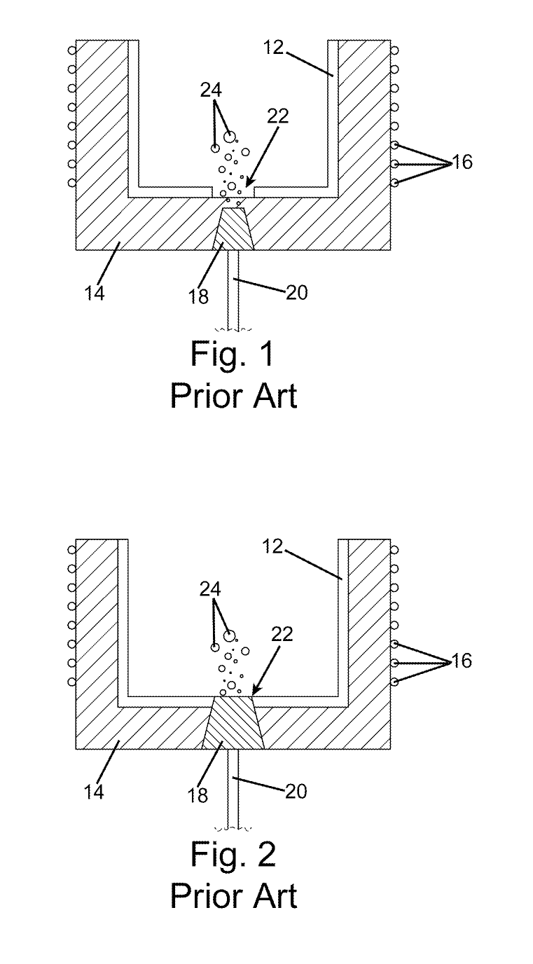

### DESCRIPTION

The present invention is related to an improved system for gas purging of molten metal. The system comprises a permeable bottom crucible having an integral permeable portion suitable for engagement with a purge plug for purging of molting metal in the permeable bottom crucible. The present invention is also related to a method of forming the improved permeable bottom crucible.

The present invention is particularly suitable for use in induction melting of metals, such as iron and nickel-based alloys, with gas purge of the molten metal. The material of construction is not particularly limited herein however, aluminosilicate crucibles are a preferred industry standard and argon is the preferred gas for purging of the molten metal in an otherwise air atmosphere.

Aluminosilicate crucibles with argon purge have proven to be suitable for use for many reasons. The formation of aluminosilicate crucibles is cost effective and well known to those of skill in the art. Aluminosilicate is sufficiently resistant to molten steel processing temperatures and is chemically resistant to corrosion and erosion in the presence of molten steel. With the instant invention, the aluminosilicate can be made selectively permeable to gas, particularly argon gas. In general, the instant invention provides a significant improvement over the current process of treating molten steel.

The invention will be described with reference to the figures forming an integral, non-limiting component of the disclosure. Throughout the disclosure similar elements will be numbered according.

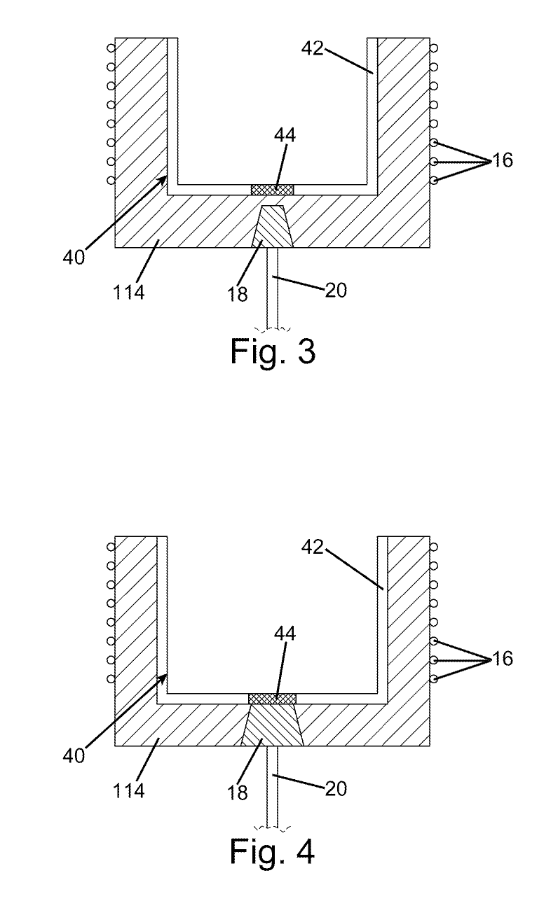

An embodiment of the invention will be described with reference to FIG. 3 wherein an inventive permeable bottom crucible is illustrated in cross-sectional schematic view. In FIG. 3, the permeable bottom crucible comprises an outer shell, 14, with an inductor coil, 16, around the outer shell. A permeable bottom crucible, 40, forms an interior lining for the shell wherein the permeable bottom crucible comprises a dense portion, 42, which is not permeable to gas and a permeable portion, 44, integral to the permeable crucible, wherein the permeable portion is permeable to pressured gas at the operating pressure of gas. The dense portion and permeable portion are continuous, preferably having the same ceramic composition, with the difference being the density of each portion. For the purposes of the present invention a permeable bottom crucible is defined as a continuous refractory crucible comprising a floor and walls wherein at least a portion of the floor is permeable to gas and the walls are not permeable to gas. The plug,18, and integral gas supply line, 20, in the permeable bottom crucible injects gas such that the gas disperses through the permeable portion, 44. The plug may be in contact with the permeable portion as illustrated in FIG. 4. It is preferable that the sides of the plug be coated with a material suitable to minimize gas exiting the side of the plug.

Preferably, the permeable bottom crucible is cast in two stages. First, the dense portion of the permeable bottom crucible is cast with a hole in the bottom using standard ceramic precursor material. A modified ceramic formulation, preferably comprising the same ceramic as the dense portion, is cast into the hole thereby forming a permeable bottom crucible precursor. The casting process is preferably done while the ceramic materials still flow under vibration so that the modified ceramic formulation intimately bonds with the ceramic material of the dense portion of the permeable bottom crucible. The result is a homogenous body comprising distinct portions each comprising a preferably common ceramic material wherein one portion has pore forming fibers therein.

The modified ceramic formulation includes porosity increasing additives. To modify the porosity the porosity increasing additives, such as fibers, are included in the ceramic precursor formulation. Upon firing the porosity increasing additives burn out leaving a void with the position, shape and size of the void being substantially the same as the space previously occupied by the porosity increasing additives. The size, shape and quantity of fiber determines the amount of porosity, the size and shape of the pores, and therefore the permeability. The resultant pores must be large enough and plentiful enough to provide sufficient gas flow through the permeable portion at the operating pressure yet small enough to limit bubble size and prevent metal ingress. The chemistry and thermal expansion properties of the ceramic material are not altered by the porosity increasing additives.

When firing the ceramic shapes, the porosity increasing materials leave voids in a discrete area in the bottom of the permeable bottom crucible that will be sufficiently higher in porosity than the rest of the permeable bottom crucible and more permeable to gas than the rest of the permeable bottom crucible. It is preferably that the dense portion is not permeable to gas under normal operating conditions. Gas introduced beneath the permeable bottom crucible will preferentially, and preferably exclusively, permeate through the permeable portion while the majority of the permeable bottom crucible remains as a dense/erosion resistant body. During the casting, drying, and co-firing the composite will remain intact as a single integral object with a permeable portion seamlessly sintered into the body of the permeable bottom crucible. The materials will therefore always be in intimate contact. A particular feature of the instant invention is the common coefficient of thermal expansion for the dense portion of the permeable bottom crucible and the permeable portion of the permeable bottom crucible thereby minimizing crack propagation during temperature cycling.

The porosity increasing additive is not particularly limiting herein. Porosity increasing additives are selected with the proviso that they occupy space, preferably connected space, within the ceramic precursor and upon firing vacate, preferably by evaporation, thereby generating a void approximating the original shape and size of the porosity increasing additive. It is preferable that the porosity increasing additive not leave a residue and therefore organic materials are most preferred. Fibers are preferred due to their shape and size which facilitates passages through the fired ceramic suitable for gas to permeate there through. Other materials, such as hollow organic spheres, can be employed as porosity increasing additives. When the ceramic precursor is fired to form a ceramic, the spheres or other fugitive material are volatilized resulting in uniformly distributed voids throughout the permeable area. Using this method a range of porosities can be achieved. The porosity and pore size is easily controlled by the number and sizes of the fugitive material used. After firing, the void is substantially the same shape and size as the included fugitive material. Other organic pore formers may be utilized, including flour, cellulose, starch and the like.

The co-firing process eliminates the need to secure a purge plug to the crucible which is usually accomplished with a mortar bond. The co-firing technique also eliminates the use of a ram in contact with the melt. In order to deliver gas to the permeable area of the permeable bottom crucible, a purge plug can be semi-permanently mounted to the bottom of the permeable bottom crucible, preferably in the shell, to supply argon through the permeable portion as illustrated in FIG. 3. Alternatively, the purge plug can be placed directly under the permeable portion within the shell, optionally in contact with the permeable portion, as in FIG. 4. Since the purge plug will not come in contact with the melt the usable life of the purge plug can be extended significantly.

The pore size is determined based on the desired permeability at the operating pressure of gas. Porosity is reported as the percentage of volume being vacant of ceramic material. For the purposes of clarity a 25% porosity would represent a ceramic which has a density of 75% of the theoretical, or crystallographic, density assuming no voids. As operating pressure increases porosity can decrease. The dense portion should have a porosity sufficiently low as to not be permeable at the intended operation pressure. Using 20 psi for the purposes of comparison, a porosity of no more than 13% is sufficient to function as a dense portion. At 20 psi, for the purposes of comparison, a porosity above about 13% is necessary to achieve adequate permeability and more preferably at least 15% porosity. Permeability increases with increasing porosity and increasing pressure. One of skill in the art could immediately determine adequate porosity at the desired gas pressure to achieve adequate flow. If the porosity exceeds an upper limit the molten metal can enter the permeable portion which is preferably avoided. A porosity of no more than 30% is preferred regardless of the operating pressure to exclude molten metal from passing into the permeable portion. As would be understood to those of skill in the art porosity can be increased by increasing the amount of porosity increasing additive.

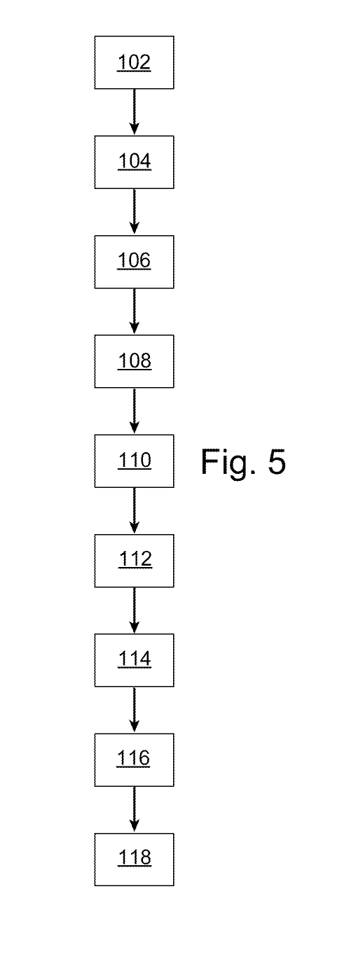

Preparation of an inductive crucible is well known in the art and not appreciable altered herein except in the formation of the permeable portion. Formation of the permeable bottom crucible will be described with reference to the flow chart of FIG. 5. In preparing a permeable bottom crucible a mold is formed in the intended shape of the eventual permeable bottom crucible, 102. The material of construction for the mold is not limited herein and any typical material used for forming induction crucibles is sufficient. Gypsum is suitable for demonstration of the invention due to the wide spread use in the industry. In a departure from conventional methods of inductive crucible formation a portion of the bottom of the mold is blocked, 104, by an exclusion member capable of inhibiting ceramic material from entering that area of the bottom of the mold where the permeable portion will be formed. While not limited thereto, a non-wetting material can be used as the exclusion member. The material of construction for the exclusion member is not particularly limited herein. Non-wetting materials are preferred. PVC pipe is a particularly preferred exclusion member due to the low cost, adequate availability, wide size availability and ease of machining or cutting to length. A ceramic precursor is cast into the mold, 106, using standard techniques with vibration being a preferred method as well known to those in the art. Any ceramic precursor known in the art for use in inductive crucibles is suitable for demonstration of the invention. Aluminosilicates have found widespread acceptance, particularly for use with steel. FMS or TA-530 crucibles, both commercially available from SELEE Advanced Ceramics, are widely accepted alumina silicate formulations and both are suitable for demonstration of the invention. A99S and 530P are other materials commercially available from, SELEE Advanced Ceramics, which are exemplary for demonstration of the invention. Once the mold is full, except for the excluded area occupied by the exclusion member, it is preferable to cease the vibration while the exclusion member is removed, 108. That portion previously occupied by the exclusion member is at least partially filled with modified ceramic precursor, 110, comprising pore formers as discussed above and vibration is preferable resumed. This vibration enables the ceramic precursor of the dense portion, which preferably does not comprise pore formers to intimately bond with the modified ceramic precursor comprising the pore formers thereby creating a seamless bond between the two ceramic mixtures. The remaining process does not differ appreciably from standard practice. The composite is completed by finishing 112, drying, 114, labeling, 116, and firing, 118, as well known to those of skill in the art.

To demonstrate the increased permeability of the permeable region, three samples prepared with A99S, TA-530 or 530P ceramic precursor were fired to high temperature and tested in a water permeability apparatus. All three samples were pressurized to 20 pounds per square inch (psi). The sample prepared with A99S having 13% porosity did not exhibit any permeability and is therefore insufficient to function as a permeable portion at 20 psi. The sample prepared with TA-530 having 16% porosity had a fair amount of fine bubbling. The sample prepared with 530P made with the same batch of TA-530 but modified with an addition of 1-wt % ARBOCEL B600 fibers (J. Rettenmaier USA, LP), to provide a 22% porosity exhibited the most vigorous bubbling. The difference in bubbling is more pronounced at 10 psi. Table 1 shows the increase in volume fraction of porosity as a function of the amount and type of incorporated fibers.

TABLE 1

| | MOR | | | |
|---|---|---|---|---|
| Fiber | (psi) | Density (g/cc) | Density (pcf) | Porosity (%) |
| None | 1710.0 | 2.87 | 180 | 16.15 |
| 1% 105 Fibers | 1267.5 | 2.64 | 165 | 23.24 |
| 1% B600 | 1451.4 | 2.70 | 168 | 21.86 |
| Fibers | | | | |
| ½% 105 Fibers | 1520 | 2.67 | 167 | 22.32 |
| ½% B600 | | | | |
| Fibers | | | | |

In Table 1, Fiber represents additional fiber beyond that incorporated in the commercially available material. MOR is Modulus of Rupture in pounds per square inch (psi). Density is presented as grams per cubic centimeter (g/cc) and pounds per cubic food (pcf).

The invention has been described with reference to the preferred embodiments without limit thereto. One of skill in the art would appreciate additional embodiments, alterations and improvements which are not specifically stated but which are within the scope of the instant invention as set forth in the claims appended hereto.

Claimed is:

1. A permeable bottom crucible for degassing molten metal comprising:
a refractory ceramic body comprising walls and an integral bottom wherein said integral bottom has a porous portion wherein said porous portion has a porosity which is higher than a porosity of said walls;
inductive coils around said refractory ceramic body; and
a plug arranged to disperse gas through said porous portion.

2. The permeable bottom crucible for degassing molten metal of claim 1 wherein said permeable portion has a permeable portion porosity sufficiently high for said gas to permeate therethrough at a gas pressure and said walls have a dense porosity sufficiently low that said gas does not permeate through said walls at said gas pressure.

3. The permeable bottom crucible for degassing molten metal of claim 2 wherein said gas pressure is 20 psi.

4. The permeable bottom crucible for degassing molten metal of claim 3 wherein said permeable portion porosity is over 13% to no more than 30%.

5. The permeable bottom crucible for degassing molten metal of claim 3 wherein said permeable portion porosity is at least 15%.

6. The permeable bottom crucible for degassing molten metal of claim 1 wherein said permeable portion represents at least a portion of said bottom.

7. The permeable bottom crucible for degassing molten metal of claim 1 further comprising a shell between said refractory ceramic body and said inductive coils.

8. A method of forming a permeable bottom crucible comprising;
forming a mold wherein said mold has a shape of said permeable bottom crucible;
inserting an exclusion member in said mold;
inserting a ceramic precursor in said mold wherein said ceramic precursor fills said mold thereby forming a dense ceramic precursor;
removing said exclusion member thereby forming a vacancy in said dense ceramic precursor;
filling said vacancy with a modified ceramic precursor wherein said modified ceramic precursor comprises porosity increasing additives thereby forming a permeable bottom crucible precursor; and
heating said permeable bottom crucible precursor to from a permeable bottom crucible comprising walls and a bottom wherein said bottom comprises a permeable portion.

9. The method of forming a permeable bottom crucible of claim 8 further comprising vibrating said dense ceramic precursor and said modified ceramic precursor.

10. The method of forming a permeable bottom crucible of claim 8 wherein said porosity increasing additives comprises fibers.

11. The method of forming a permeable bottom crucible of claim 8 wherein said permeable portion has a permeable portion porosity sufficiently high for said gas to permeate therethrough at a gas pressure and said walls have a dense porosity sufficiently low that said gas does not permeate through at said gas pressure.

12. The method of forming a permeable bottom crucible of claim 11 wherein said gas pressure is 20 psi.

13. The method of forming a permeable bottom crucible of claim 12 wherein said permeable portion porosity is over 13% to no more than 30%.

14. The method of forming a permeable bottom crucible of claim 13 wherein said permeable portion porosity is at least 15%.

15. The method of forming a permeable bottom crucible of claim 8 wherein said permeable portion represents at least a portion of said bottom.

16. The method of forming a permeable bottom crucible of claim 8 further comprising providing a purge plug capable of providing gas flow to said permeable portion.

17. The method of forming a permeable bottom crucible of claim 8 further comprising forming an inductive coil around said permeable bottom crucible.

18. The method of forming a permeable bottom crucible of claim 17 further comprising a shell between said permeable bottom crucible and said inductive coil.
